(19) United States
(12) Patent Application Publication
(10) Pub. No.: US 2004/0037077 A1
(43) Pub. Date: Feb. 26, 2004

(54) Illumination of signs and system for providing signs

(76) Inventors: David Field Showers, Malvern (AU); Malcolm Wesley Oldis, Yarrambat (AU); Kenneth Robert Goddard, Eltham (AU); Scott Victor Pitcher, Doncaster East (AU)

Correspondence Address: WILLIAM COLLARD, COLLARD & ROE, P.C., 1077 NORTHERN BOULEVARD, ROSLYN, NY, 11576, US

(21) Appl. No.: 10/296,647

(22) PCT Filed: May 28, 2001
(86) PCT No.: PCT/AU01/00630

(30) Foreign Application Priority Data
May 26, 2000 (AU) PQ 7779
Feb. 26, 2001 (AU) PR 3382

(51) Int. Cl. F21V 21/00

(52) U.S. Cl. 362/249; 362/235

(57) ABSTRACT

A sign illumination kit includes lamp support means adapted to be trimmed for location in co-operation with structure defining a sign or sign segment. Means forming, or divisible to form, a plurality of illumination elements each has a mount component and one or more solid state lamp devices mounted thereon, which elements may be arranged in sets of varying size and shape. Means is provided for attaching the illumination elements to lamp support means in an assembly in which the solid state lamp devices when activated cause the sign or sign segment to be illuminated.

### FIELD OF THE INVENTION

This invention relates to the illumination of signs and is concerned both with the provision of such illumination and with a method of supplying illuminated signs involving the cooperation of signmakers and component suppliers.

### BACKGROUND TO THE INVENTION

Illuminated display signs are conventionally formed either as neon tubes or as translucent panels backlit by fluorescent or like tubes, or by incandescent lamps. Sign making tends to be an industry built around custom tailoring to suit specific sites and specific customers. For example, a large sign containing lettering would require preparation of individual housings defining letters and the provision of lighting systems for the respective letters.

Solid state lamp devices, most commonly light emitting diodes (LEDs), are widely employed for small scale indicator and display purposes, but in more recent times have come into use in illumination applications. This development has become feasible as the light output and uniformity of LEDs has been progressively enhanced.

A limitation in general with signs formed by an array of lamps, whether LEDs or otherwise, is that they require a fixed regular array of the lamps in known positions. The associated control systems cannot accommodate customer-driven variations of size or shape of the lamp array configuration, or substitution of lamps or lamp sub-arrays between positions in the array.

### SUMMARY OF THE INVENTION

The present invention, in its various aspects, stems from an appreciation that there is an opportunity to adapt the aforementioned advances with LEDs and other solid state lamp devices to the technology of illuminated signs, and to the way in which signmakers go about their business. In a particular aspect, the invention addresses the described limitation with signs formed by an array of lamps.

In a first aspect, the invention provides a sign illumination kit including lamp support means adapted to be trimmed for location in co-operation with structure defining a sign or sign segment. Means is provided forming, or divisible to form, a plurality of illumination elements each having a mount component and one or more solid state lamp devices mounted thereon, which elements may be arranged in sets of varying size and shape. The kit further includes means for attaching the illumination elements to the lamp support means in an assembly in which the solid state lamp devices when activated cause the sign or sign segment to be illuminated.

Preferably, said solid state lamp devices when activated are able to backlight overlying translucent sheet material and thereby cause said illumination of the sign or sign segment.

Preferably, the kit further includes translucent sheet material adapted to be trimmed for location in co-operation with said structure in a position that overlies the lamp support means.

In a second aspect, the invention provides an illuminated sign assembly, that includes structure defining a sign or sign segment, and lamp support means trimmed for location in co-operation with the structure. A plurality of illumination elements each has a mount component and one or more solid state lamp devices mounted thereon, which elements are arranged in sets of varying size and shape. Means is provided attaching the illumination elements to the lamp support means so that, on activation, the solid state lamp devices cause the sign or sign segment to be illuminated.

The assembly preferably further includes translucent sheet material trimmed for location in co-operation with said structure in a position overlying the lamp support means, whereby, on activation, said solid state lamp devices backlight the translucent sheet material.

In a still further aspect of the invention, there is afforded a method of providing an illuminated sign or sign segment, including:

obtaining a sign illumination kit according to the first aspect of the invention;

forming structure defining a sign or sign segment;

trimming lamp support means contained in said kit, for co-operation with said structure;

selecting from the kit a plurality of said illumination elements for arrangement in a set to match the sign or sign segment; and

attaching the illumination elements to the structure and forming an assembly in which, on activation, the solid state lamp devices cause the sign or sign segment to be illuminated.

Preferably, said trimming step further includes trimming translucent sheet material for co-operation with said structure and with the lamp support means whereby the trimmed translucent sheet material overlies said structure and the solid state lamp devices, on activation, backlight the translucent sheet material.

In a typical application, the structure defining the sign or sign segment is a frame or form for a character or symbol, and may be fashioned in metal sheet. The lamp support means may conveniently include an escutcheon plate mounted within the frame or form. Preferably, this plate has a plurality of apertures in or behind which the solid state lamp devices are respectively located in the assembly.

The means forming or divisible to form the plurality of illumination elements is preferably a printed circuit board (PCB) on which the solid state lamp devices are mounted in an array. Preferably this board is divisible by having lines of weakness, eg. score or fold lines, at which the board may be divided to form smaller sub-segments of the board of similar or varying shapes.

The attachment means may conveniently comprise multiple clips for fixing the illumination elements to said structure or to the escutcheon plate or both. One suitable form of clip is a deformable holder for a solid state lamp device which also releasibly engages a respective aperture in the escutcheon plate.

The invention in its first three aspects affords the possibility of establishing a supply arrangement in which signmakers may readily customise signs utilising kits according to the first aspect of the invention. To this end, in a fourth aspect, the invention extends to a method for facilitating the supply of illuminated signs, including:

receiving orders for kits according to the first aspect of the invention, which kits include one or more of the lamp support means and illumination elements to facilitate formation of a predetermined sign or sign segment; and

assembling and delivering such kits as ordered.

The orders may be received online and contain information concerning the predetermined sign or sign segment, whereby the contents of the delivered order may be adapted to suit.

Preferably, where the orders are received online, each order includes a selection by the party placing the order of a plurality of illumination elements, which selection is made by arranging on a computer screen, preferably on a grid on the screen, an array of representations of illumination elements picked from a set of representations of available different illumination elements. Advantageously, this is effected by providing the party online with access to the screen and the set of representations of available illumination elements, eg. via the receiver's webpage, by direct online computer link, or by downloading a program to the party's computer.

The available illumination elements preferably include respective different linear and rectilinear arrays of solid state lamp devices, and may include a single solid lamp device.

In a fifth aspect, the invention provides a lighting system comprising:

means forming, or divisible to form, a plurality of illumination elements each having a mount component and one or more solid state lamp devices mounted thereon, which elements may be arranged in sets of varying size and shape;

means to supply electrical power to the solid state lamp devices; and

means to individually control the operational state of each of said lamp devices, including a circuit connected to each lamp device and programmable control means in said circuit;

wherein said programmable control means includes an updatable memory stored characteristic address for the location of each lamp device, whereby said array can be flexibly predetermined or flexibly re-arranged and the location therein of lamp devices updated in said memory to facilitate a predetermined control of the lamp devices.

A particularly advantageous embodiment of the invention is a combination of the fourth aspect, especially one or more of the aforedescribed preferments, and the fifth aspect of the invention.

### BRIEF DESCRIPTION OF THE DRAWINGS

The invention will be further described, by way of example only, with reference to the accompanying drawings, in which:

FIG. 1 diagrammatically illustrates in cross-section, and not to scale, the principal elements of a sign assembly in accordance with the embodiment of the invention;

FIG. 2 is a diagrammatic exploded view depicting some of the steps involved in forming an illuminated sign comprising a large uppercase A;

FIG. 3 is a plan view of the assembled sign of FIG. 2;

FIG. 4 is a simplified flow chart of the steps required to be carried out by a signmaker in providing a sign ordered by a customer;

FIG. 5 illustrates diagrammatically alternative forms of divisible printed circuit board and the relationship of these elements to the escutcheon plate;

FIG. 6 is a diagram depicting the control elements for a representative light emitting diode lamp mounted on the printed circuit board;

FIG. 7 is a view corresponding to FIG. 6 for a group of individually mounted LEDs;

FIG. 8 is a view similar to FIG. 1 depicting the use of an extruded separator;

FIG. 9 illustrates the use of the separator in a three dimensional view;

FIG. 10 illustrates, in a view again similar to FIG. 1, a further modification utilising a spacer for setting illumination pattern; and

FIG. 11 depicts a computer program user-interactive interface screen, “Sign Builder”, employed in making selections in the sign ordering process.

### EMBODIMENTS OF THE INVENTION

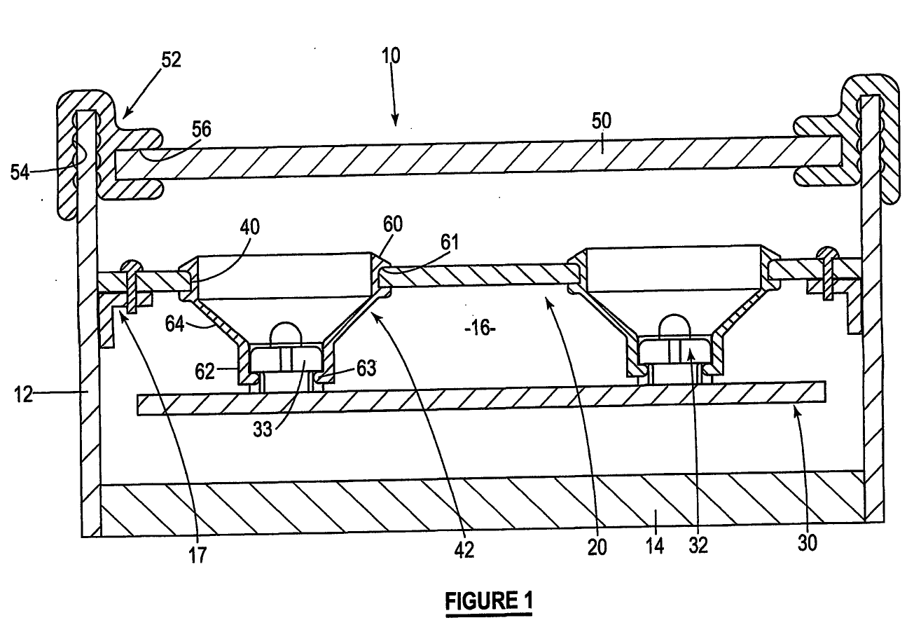

FIG. 1 illustrates in cross-section the principal components of a very simple illuminated sign (10) of undefined shape in plan. The actual shape, which may well be an alpha or numeric character or other recognisable symbol, is defined by an upstanding frame (12) of metal sheet fixed to a base plate (14), extending about an open topped space (16).

Mounted at a point of space (16) by brackets (17) is an escutcheon plate (20) which has typically been trimmed from a larger piece selected to suit the size and shape of the sign. Attached to and suspended from escutcheon plate (20) is an illumination element comprising a printed circuit board (30) (PCB) on which is mounted an array of light emitting diodes (LEDs) (32). The PCB includes circuits for supplying electrical power, eg. 5 volt DC, to the solid state lamp devices comprising LEDs 32, and for individually controlling the ON-OFF state of each LED.

The array of LEDs and their spacing is arranged to match the spacing of multiple apertures (40) in escutcheon plate (20) and the preferred manner of suspending PCB (30) from plate (20) is by means of the multiple deformable hollow mounting clips (42). The shape and structure of clips (42) will be discussed further below.

Overlying the sub-assembly of the escutcheon plate and PCB (30) with LEDs (32) is translucent lens sheet (50) which, like escutcheon plate (20), has been trimmed from a larger sheet of suitable material. Lens sheet (50) is held in place just inside the rim of frame (12) by sealing edge extrusions (52). Extrusions (52) have a first channel (54) by which the extension is fitted onto the frame plate (12), and a deformable laterally directed groove (56) that receives the rim of lens sheet (50).

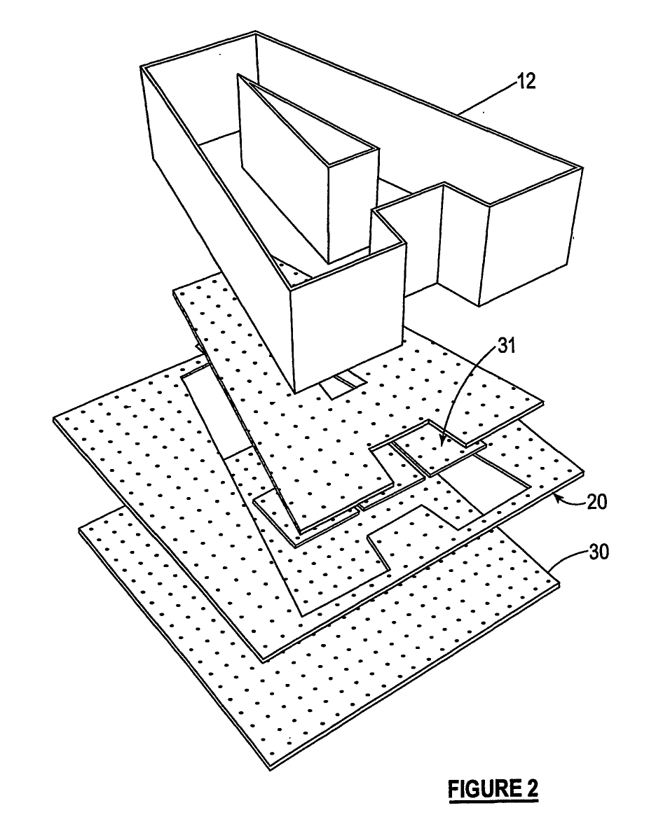

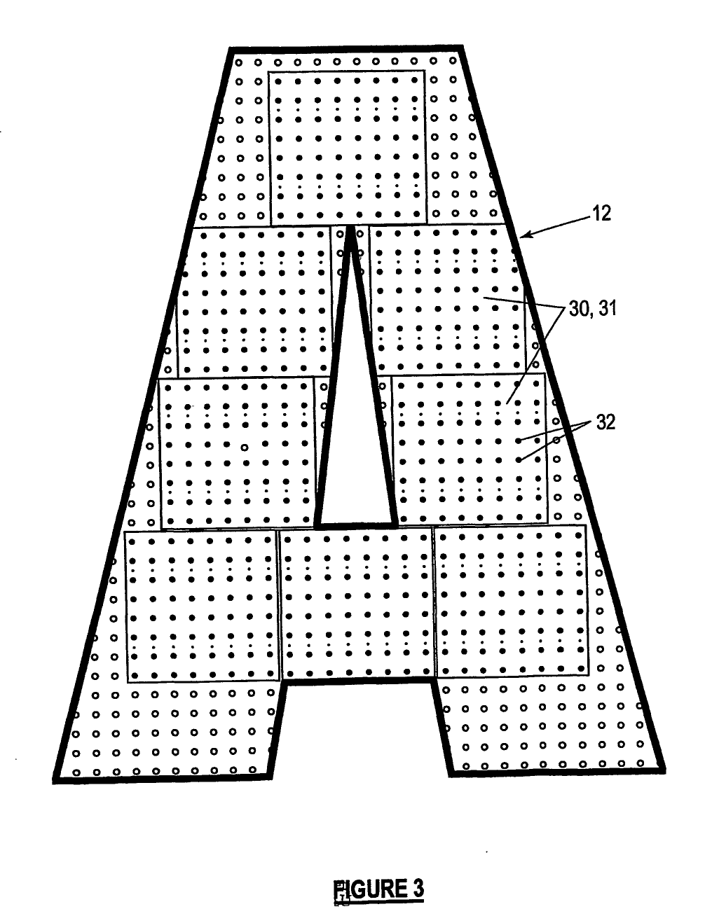

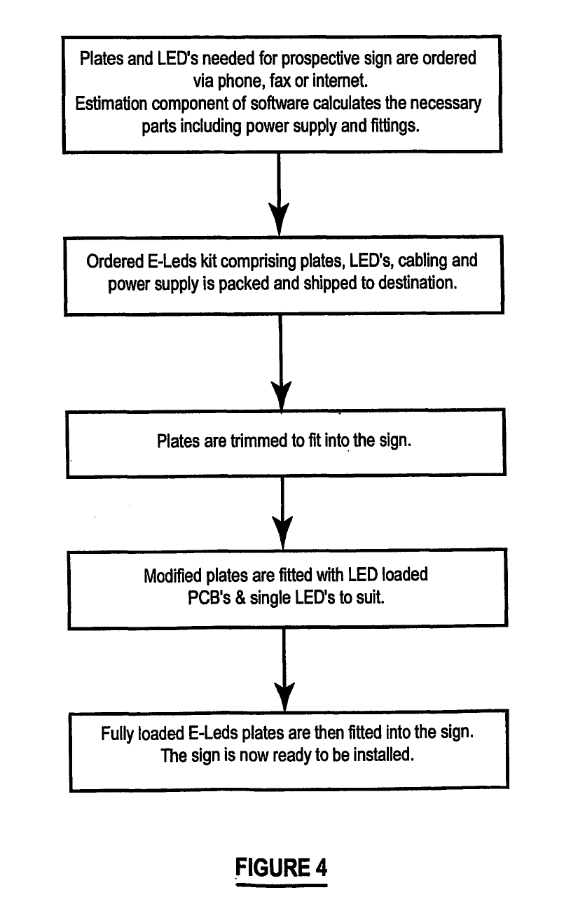

The sign of FIG. 1 is simplified for purposes of explanation. FIGS. 2 and 3 show an exemplary sign comprising an enlarged uppercase A and it is now proposed to describe the formation of this sign by a signmaker with reference to FIGS. 1 to 3 and also to FIG. 4.

Once the signmaker has settled the form of a prospective sign with a customer, the signmaker orders an appropriate supply of one or more kits of escutcheon plates (20), PCBs (30) with mounted LEDs (32), individual LEDs and control equipment (to be discussed). The order may be placed by telephone, facsimile or online, eg. via the internet.

The ordered kit including required cabling, power supply and controllers is packed and delivered to the signmaker, who first trims one or more escutcheon plates to fit into the sign frame which he has in the meantime formed from plate material. The lens sheet is also trimmed to suit the sign.

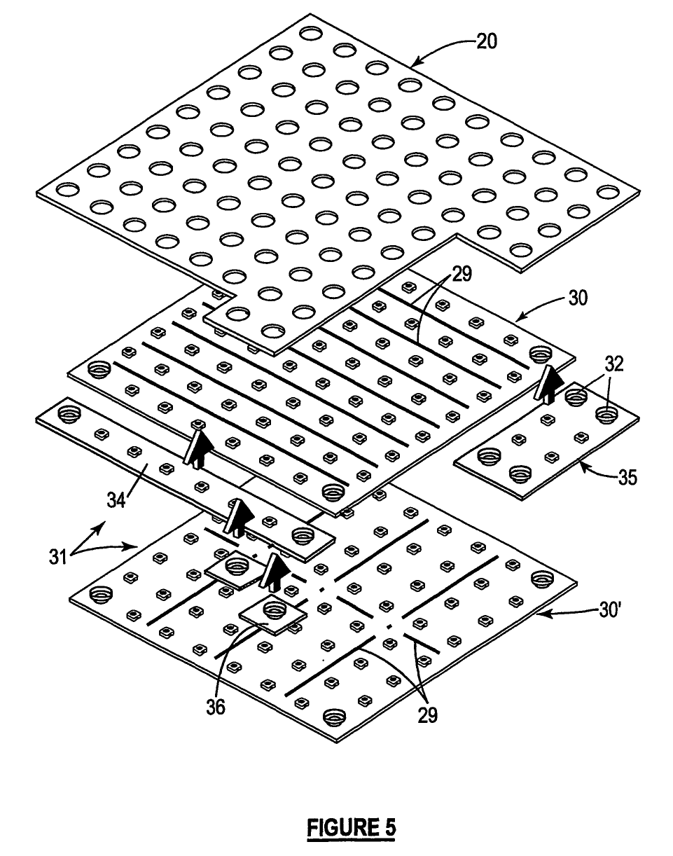

FIG. 5 illustrates some examples of formats in which the PCB sheets with mounted LEDs (32) might be received. The PCB sheets may include lines of weaknesses (29), eg. score, fold or break lines, at which the boards may be divided, eg. by snapping off to form separate illumination elements or sub-boards (31) such as the multi-LED strip (34), 4×4 rectangle (35) and single-LED pieces (36).

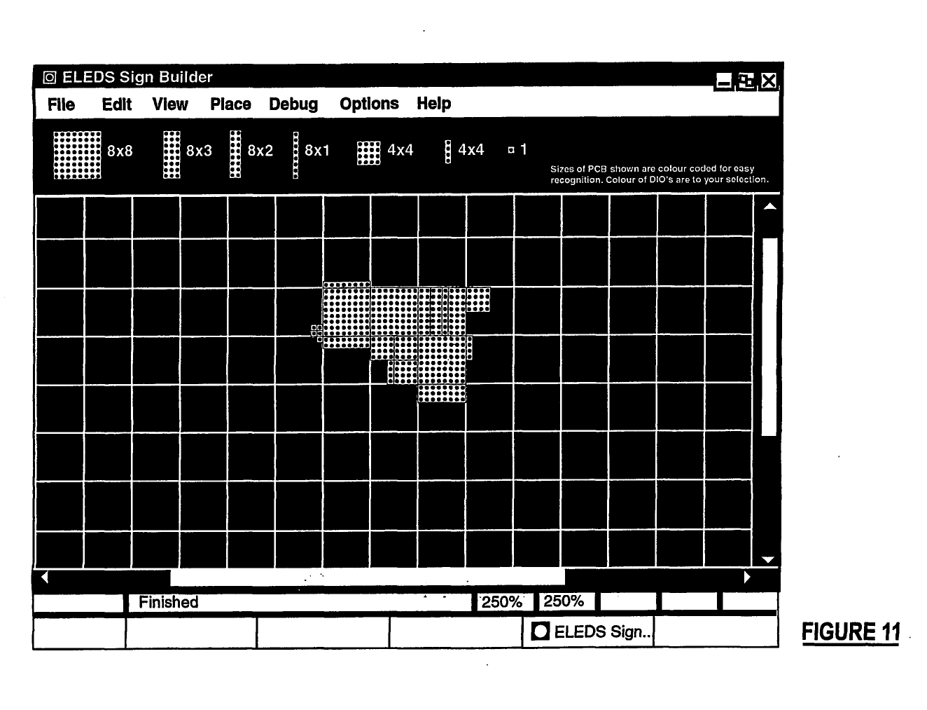

The resultant illumination elements or sub-boards can then be arranged to cover the area defined by the sign, with residual areas to be filled in by single LEDs or other sub-pieces. This process is depicted for the uppercase A sign in FIG. 3. In this way, the sub-assembly of the escutcheon plate and attached LEDs (32) is mounted together, the sub-assembly mounted within the sign frame (12), and the sign assembly completed by fixing the lens sheet (50).

Where orders are placed online, the customer signwriter may determine the array or arrangement of PCB boards 30 and sub-PCB illumination elements 31 by arranging the array on a computer screen from a set of available different illumination elements. One way of effecting this is depicted in FIG. 11, ie. access to a computer program user-interactive interface screen entitled “sign Builder” having a grid on which the ordering party builds up the array by dragging selections from the bar of icons signifying eight available LED arrays, including a single LED. This screen preferably uses a Microsoft Windows (Trade Marks) operating system, or similar operating system such as Unix (Trade Mark), and access to it can be supplied, eg. by logging on to a website of the kit supply company, by dial-up or other direct online computer link, or by pre-downloading software onto the ordering party's computer. Once the array is constructed, it may be sent or entered to record this component of the order.

Reverting again to FIG. 1, more will now be said about the hollow mounting clips (42). These clips are formed in a plastic-type material, and comprise an injection molded plastic component having an enlarged annular end (60), a smaller annular end (62) and an intervening integral frustoconical portion (64). Enlarged end (60) has an external peripheral groove (61) by which the clip can be deformed and fitted within an aperture (40) to engage the rim of the aperture in the groove (61).

The smaller end (62) of the clip has an internal bead (63) at its mouth at which the clip deforms to receive housing (33) of the LED, the bead (63) snapping under this housing to maintain the attachment.

Typically, PCB (30) or sub-PCB illumination elements (31) are not separately mounted to the frame but are mounted solely by multiple mounting clips (42).

It will be appreciated that, in an arrangement of the type shown for example in FIG. 3, only some LEDs for each PCB segment need be attached with mounting clips to the escutcheon plate.

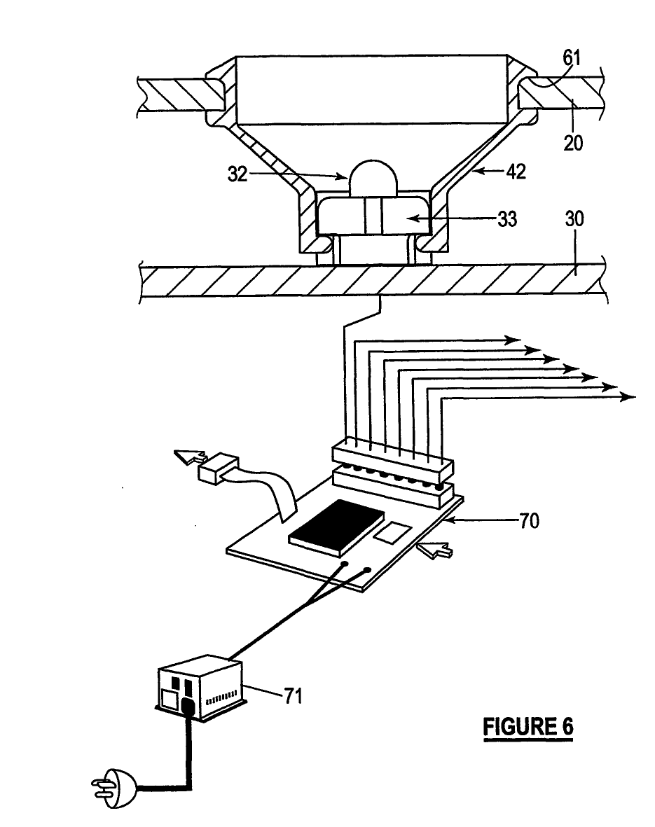

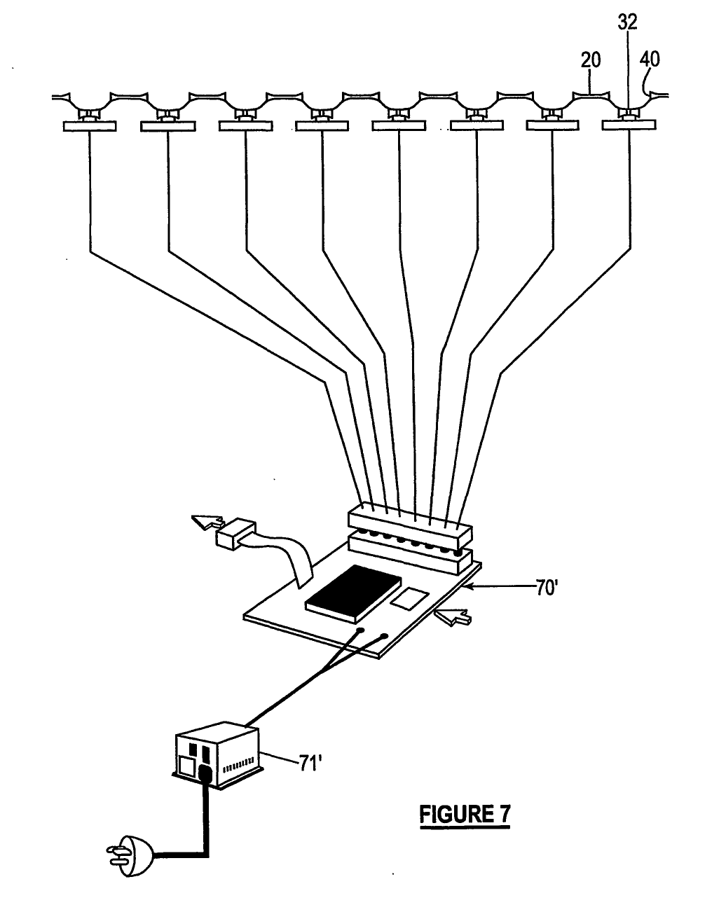

FIGS. 6 and 7 illustrate the main components of an operational sign. The LED outputs are managed by logic devices (70) fed with a DC voltage, eg of 5 volts, delivered by a transformer 71 coupled to mains power. The LED logic devices are of known form and may be readily programmed to create variable colour effects and/or dynamic patterns in the light output of the LEDs. All of the LEDs of a given sign may be single logic block or there may be multiple logic blocks daisy-chained together for overall management of light output and effects.

Advantageously, the control program for the LED logic devices includes provision for ascribing a unique array address to each LED location. Once the arlier discussed pattern of PCBs 30 and sub-PCB illumination elements 31 has been selected, a computer managing the LED logic devices can be employed to input data as to the location of each PCB 30 and sub-PCB element 31. The computer determines the address of each LED from this data. With this approach it is a simple matter to interchange or otherwise subsequently modify the LED array, provided the location change is input in the control program.

In practice, on-off settings for each display of the LED array are fed to the array, via one or more input points, as a serial bit stream and then a trigger signal is transmitted to light all LEDs with an ON bit setting.

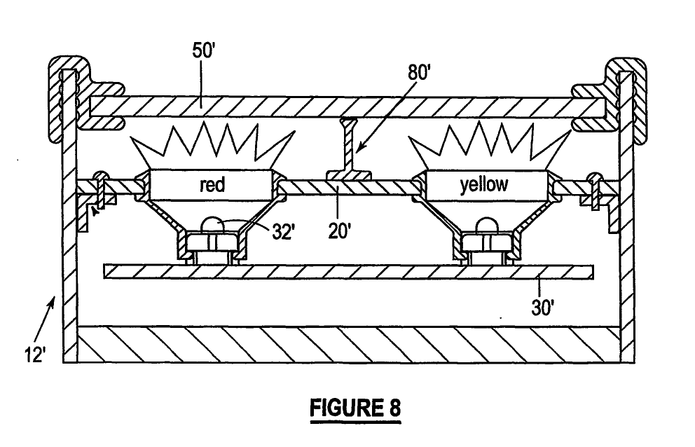

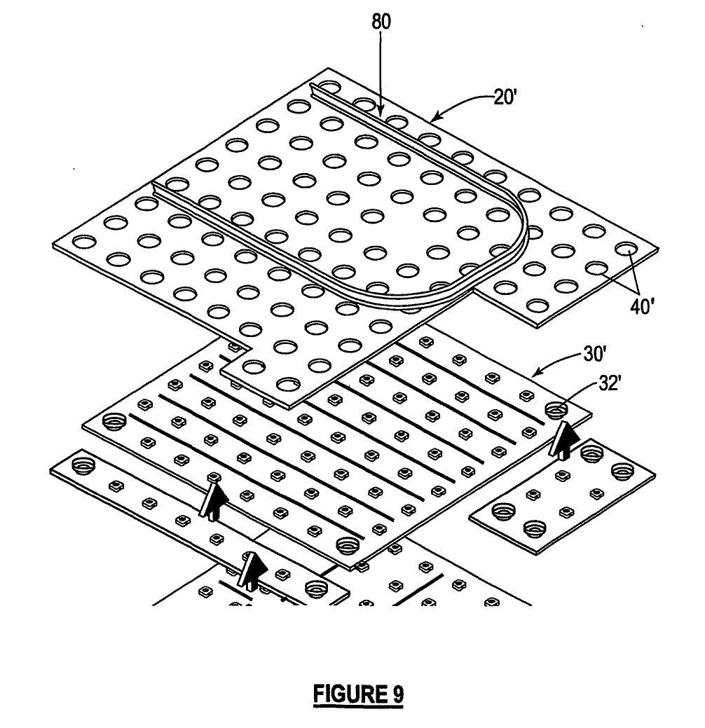

The LEDs of a given sign may of course be different colours, or multi-colour. FIGS. 8 and 9 illustrate a modification in which a flexible opaque extruded separator (80) is used to separate areas of differing colours regardless of shape. This will facilitate the use of LED lamps of different colour and permit multi-coloured signs greater definition, allowing for many new sign design possibilities. The separator may be mechanically or chemically fixed to the escutcheon plate.

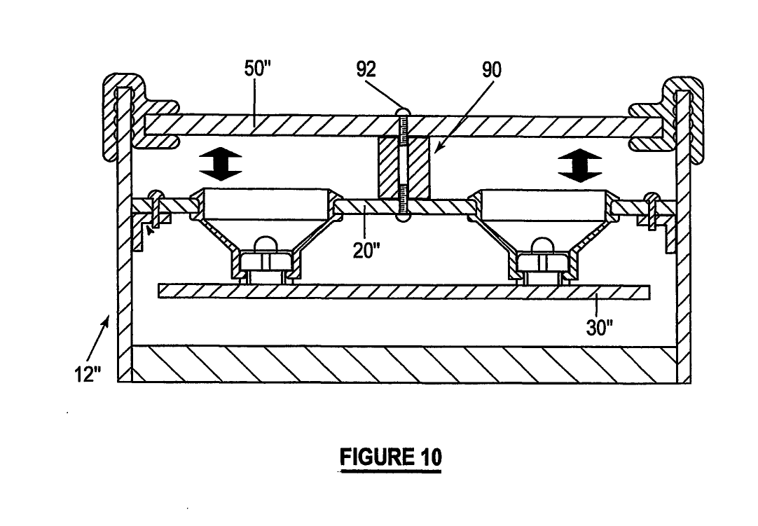

FIG. 10 depicts another modification in which a spacer (90) is arranged between the lens sheet and escutcheon plate. These spacers are preferably clear acrylic rods tapped at either end for attachment with screws (92) to the lens sheet and escutcheon plate. They will typically come in a range of heights to allow the installer to alter the illuminated area on the lens sheet (50). This varying of the height varies the diffusion of the light coming from the LEDs, and offers the installer a fuller variety of lighting effects to best suit the application.

It will be appreciated that the illuminated signs may be provided in a floor or wall setting.

1 A sign illumination kit including:
lamp support means adapted to be trimmed for location in cooperation with structure defining a sign or sign segment;
means forming, or divisible to form, a plurality of illumination elements each having a mount component and one or more solid state lamp devices mounted thereon, which elements may be arranged in sets of varying size and shape; and
means for attaching the illumination elements to the lamp support means in an assembly in which the solid state lamp devices when activated cause the sign or sign segment to be illuminated.

2 A sign illumination kit according to claim 1, wherein said solid state lamp devices when activated are able to backlight overlying translucent sheet material and thereby cause said illumination of the sign or sign segment.

3 A sign illumination kit according to claim 1 or 2 wherein said kit further includes translucent sheet material adapted to be trimmed for location in co-operation with said structure in a position that overlies the lamp support means.

4 A sign illumination kit according to claim 1, 2 or 3 wherein said lamp support means includes an escutcheon plate mounted within the frame or form.

5 (amended) A sign illumination kit according to claim 4, wherein said escutcheon plate has a plurality of apertures in or behind which the solid state lamp devices are respectively located in the assembly.

6 A sign illumination kit according to any preceding claim wherein said means forming, or divisible to form, the plurality of illumination elements is a printed circuit board (PCB) on which the solid state lamp devices are mounted in an array.

7 A sign illumination kit according to claim 6, wherein said board is divisible by having lines of weakness, eg. score or fold lines, at which the board may be divided to form smaller subsegments of the board of similar or varying shapes.

8 A sign illumination kit according to any preceding claim, wherein said attachment means comprises multiple clips for fixing the illumination elements to said structure or to the escutcheon plate or both.

9 A sign illumination kit according to claim 8 wherein said clip is a deformable holder for a solid state lamp device which also releasibly engages a respective aperture in the escutcheon plate.

10 An illuminated sign assembly, including:
structure defining a sign or sign segment;
lamp support means trimmed for location in co-operation with said structure;
a plurality of illumination elements each having a mount component and one or more solid state lamp devices mounted thereon, which elements are arranged in sets of varying size and shape; and
means attaching the illumination elements to the lamp support means so that, on activation, the solid state lamp devices cause the sign or sign segment to be illuminated.

11 An assembly according to claim 10, further including translucent sheet material trimmed for location in co-operation with said structure in a position overlying the lamp support means, whereby, on activation, said solid state lamp devices backlight the translucent sheet material.

12 An assembly according to claim 10 or 11, wherein said structure defining the sign or sign segment is a frame or form for a character or symbol.

13 An assembly according to claim 10, 11 or 12 wherein said lamp support means includes an escutcheon plate mounted within the frame or form.

14 An assembly according to claim 13, wherein said escutcheon plate has a plurality of apertures in or behind which the solid state lamp devices are respectively located in the assembly.

15 An assembly according to any one of claims 10 to 14 wherein said attachment means comprises multiple clips for fixing the illumination elements to said structure or to the escutcheon plate or both.

16 An assembly according to claim 15 wherein said clip is a deformable holder for a solid state lamp device which also releasibly engages a respective aperture in the escutcheon plate.

17 (amended) A method of providing an illuminated sign or sign segment, including:
obtaining a sign illumination kit according to any one of claims 1 to 9;
forming structure defining a sign or sign segment;
trimming lamp support means contained in said kit, for co-operation with said structure;
selecting from the kit a plurality of said illumination elements for arrangement in a set to match the sign or sign segment; and
attaching the illumination elements to the structure and forming an assembly in which, on activation, the solid state lamp devices cause the sign or sign segment to be illuminated.

18 A method according to claim 17 wherein said trimming step further Includes trimming translucent sheet material for co-operation with said structure and with the lamp support means whereby the trimmed translucent sheet material overlies said structure and the solid state lamp devices, on activation, backlight the translucent sheet material.

19 A method for facilitating the supply of illuminated signs, including:
receiving orders for kits according to any of claims 1 to 9, which kits include one or more of the lamp support means and illumination elements to facilitate formation of a predetermined sign or sign segment; and
assembling and delivering such kits as ordered.

20 A method according to claim 19 wherein said orders are received online and contain information concerning the predetermined sign or sign segment, whereby the contents of the delivered order may be adapted to suit.

21 A method according to claim 20 wherein each order includes a selection by the party placing the order of a plurality of illumination elements, which selection is made by arranging on a computer screen representations of an array of illumination elements picked from a set of representations of available different illumination elements.

22 A method according to claim 21 further including arranging said representations on a grid on said computer screen.

23 A method according to claim 21 or 22, wherein said selection is effected by providing the party online with access to the screen and the set of representations of available illumination elements, eg. via the receiver's webpage, by direct online computer link, or by downloading a program to the party's computer.

24 A method according to any one of claims 19 to 23, wherein said illumination elements include respective different linear and rectilinear arrays of solid state lamp devices.

25 A method according to claim 24 wherein said illumination elements include a single solid lamp device.

26 (amended) A lighting system comprising:
means forming, or divisible to form, a plurality of illumination elements each having a mount component and one or more solid state lamp devices mounted thereon, which elements may be arranged in sets of varying size and shape;
means to supply electrical power to the solid state lamp devices; and
means to individually control the operational state of each of said lamp devices, including a circuit connected to each lamp device and programmable control means in said circuit;
wherein said programmable control means includes an updatable memory stored characteristic address for the location of each lamp device, whereby said array can be flexibly predetermined or flexibly re-arranged and the location therein of lamp devices updated in said memory to facilitate a predetermined control of the lamp devices.
